(19) United States
(12) Patent Application Publication
(10) Pub. No.: US 2021/0360326 A1
(43) Pub. Date: Nov. 18, 2021

(54) AGENT COOPERATION DEVICE, OPERATION METHOD THEREOF, AND STORAGE MEDIUM

(71) Applicant: TOYOTA JIDOSHA KABUSHIKI KAISHA, Toyota-shi (JP)

(72) Inventor: Kohki TAKESHITA, Tokyo (JP)

(73) Assignee: TOYOTA JIDOSHA KABUSHIKI KAISHA, Toyota-shi (JP)

(21) Appl. No.: 17/314,359

(22) Filed: May 7, 2021

(30) Foreign Application Priority Data
May 18, 2020 (JP) 2020-086958

(51) Int. Cl. H04N 21/472; H04N 21/233; G10L 15/22

(52) U.S. Cl. CPC H04N 21/47217; G10L 2015/223; G10L 15/22; H04N 21/233

(57) ABSTRACT

An agent cooperation device includes: a sound output section that controls sound output in accordance with instructions from plural agents that are configured to receive an instruction regarding a predetermined service by voice dialogue; and a control section that, in a case in which a voice dialogue is provided with respect to one of the plural agents while another agent is playing music or an audiobook as a service, controls the sound output section so as to lower a volume of or stop playback that is being carried out by the other agent.

### CROSS-REFERENCE TO RELATED APPLICATION

This application is based on and claims priority under 35 USC 119 from Japanese Patent Application No. 2020-086958 filed on May 18, 2020, the disclosure of which is incorporated by reference herein.

### BACKGROUND

The present disclosure relates to an agent cooperation device, an operation method thereof, and a storage medium on which an agent cooperation program is stored, which use services that are provided by plural agents.

### RELATED ART

Japanese Patent Application Laid-Open (JP-A) No. 2018-189984 discloses, as a voice dialogue method for using the services of two agents, deciding-on which of the two agents will carry out handling, on the basis of agent information such as a keyword or the like that identifies the agent. Specifically, a voice dialogue agent that is a home agent receives an input voice signal, carries out voice recognition processing on the inputted voice signal, and, on the basis of the results of the voice recognition processing and the agent information, decides which of the home agent or another vehicle agent will carry out the processing based on the input voice signal. In this deciding process, in a case in which it is decided that the processing is to be carried out at the home agent, the home agent carries out processing based on the results of the voice recognition processing, and generates and outputs a response voice signal relating to that processing. In a case in which it is decided that the processing is to be carried out at the vehicle agent, the home agent transfers the input voice signal to a vehicle agent server.

However, in JP-A No. 2018-189984, in a case in which a user performs a voice dialogue with respect to another agent while one agent among the plural agents is playing music or an audiobook, the sound that is being played and the voice dialogue will intermingle, and it will be difficult for the user to hear the response voice given by the voice dialogue. Therefore, there is room for improvement in this technique.

### SUMMARY

The present disclosure has been made in view of the above-described circumstances, and provides an agent cooperation device, an operation method thereof, and a storage medium that stores an agent cooperation program, which may improve the audibility of a response voice given by a voice dialogue in a case in which, while one agent among plural agents is playing music or an audiobook, a voice dialogue is provided with respect to another agent.

A first aspect of the present disclosure is an agent cooperation device including: a sound output section that controls sound output in accordance with instructions from plural of agents that are configured to receive an instruction regarding a predetermined service by voice dialogue; and a control section that, in a case in which a voice dialogue is provided with respect to one of the plural agents while another agent is playing music or an audiobook as a service, controls the sound output section so as to lower a volume of or stop playback that is being carried out by the other agent.

In accordance with the first aspect, the sound output section controls sound output in accordance with instructions from plural agents that is configured to receive instructions of predetermined services by voice dialogue.

Further, the control section controls the sound output section such that in a case in which a voice dialogue is provided with respect to one of plural agents while another agent is playing music or an audiobook as a service, the volume of the playback that is carried out by the other agent is lowered or the playback is stopped. Due thereto, the first aspect may improve the audibility of a response voice given by a voice dialogue in a case in which a voice dialogue is provided with respect to one of plural agents while another agent is playing music or an audiobook.

The control section may control the sound output section so as to lower the volume of the playback that is being carried out by the other agent in a case in which the one agent receives a voice dialogue during the playback, and to stop sound of the playback when the one agent outputs a response voice to the voice dialogue. Due thereto, the audibility of a response voice given by a voice dialogue may be improved, and the playback of an audiobook or music provided by the other agent may be carried out while omitting an instruction to stop the sound being played.

The control section may control the sound output section so as to lower the volume of the playback that is being carried out by the other agent in a case in which the one agent receives a voice dialogue during the playback, to stop sound of the playback while the one agent outputs a response voice, and to restart the sound of the playback after the voice dialogue with the one agent ends. Due thereto, the audibility of the response voice of the another agent may be improved, even during playback of music or an audiobook.

The control section may control the sound output section so as to, in a case in which the one agent is to play music or an audiobook, while the other agent is playing music or an audiobook, lower a volume of the playback that is being carried out by the other agent when the one agent receives the voice dialogue, and stop the playback of the music or the audiobook by the other agent when the one agent starts playback of music or an audiobook. Due thereto, the audibility of the response voice given by a voice dialogue may be improved, and the playback of an audiobook or music that is provided by the other agent may be carried out while omitting an instruction to stop the sound that is being played.

The control section may control the sound output section so as to, in a case in which the one agent is to output a response voice to a voice dialogue while the other agent is playing music or an audiobook, lower a volume of the playback that is being carried out by the other agent when the one agent receives the voice dialogue, and restore the volume of the playback that is being carried out by the other agent after the one agent outputs the response voice. Due thereto, the audibility of the response voice of the another agent maybe improved, even during playback of music or an audiobook.

A second aspect of the present disclosure is a method of operating an agent cooperation device that includes functions of plural agents that are configured to receive an instruction regarding a predetermined service by voice dialogue, and a sound output section that controls sound output from the plural agents, the method including: detecting a voice dialogue with respect to one agent among the plural agents; determining whether or not another agent among the plural agents is playing music or an audiobook as the service; and controlling the sound output section so as to lower a volume of or stop playback that is being carried out by the other agent, in a case in which it is determined that the other agent is carrying out the playback.

A third aspect of the present disclosure is a non-transitory storage medium storing a program that is executable by a computer to perform agent cooperation processing, the computer being configured to perform functions of plural agents that receive an instruction regarding a predetermined service by voice dialogue, and of a sound output section that controls sound output from the plural agents, the agent cooperation processing including: detecting a voice dialogue with respect to one agent among the plural agents; determining whether or not another agent among the plural agents is playing music or an audiobook as the service; and controlling the sound output section so as to lower a volume of, or stop, playback that is being carried out by the other agent, in a case in which it is determined that the other agent is carrying out the playback.

In the second and third aspects as well, similarly to the first aspect, the audibility of a response voice given by a voice dialogue may be improved in a case in which a voice dialogue is provided with respect to one of plural agents while another agent is playing music or an audiobook.

As described above, in accordance with the present disclosure, there can be provided an agent cooperation device, a method of operation thereof, and a storage medium that stores an agent cooperation program, which can make it easy to hear a response voice given by a voice dialogue in a case in which, while one agent among plural agents is in the midst of playing back music or an audiobook, a voice dialogue is carried out with respect to another agent.

### BRIEF DESCRIPTION OF THE DRAWINGS

FIG. 1 is a block diagram illustrating a schematic structure of an agent cooperation device relating to a present embodiment.

FIG. 2 is a flowchart illustrating an example of a processing flow carried out at a voice sensing section at the agent cooperation device relating to the present embodiment.

FIG. 3 is a flowchart illustrating an example of a specific processing flow carried out at an A2A cooperation control section at the agent cooperation device relating to the present embodiment.

FIG. 4 is a flowchart illustrating an example of response output processing.

FIG. 5 is a sequence diagram illustrating a case in which, at an agent cooperation device 10 relating to the present embodiment, a first agent 22 is instructed to playback music, during playback of an audiobook by a second agent 24.

FIG. 6 is a sequence diagram illustrating a case in which, at the agent cooperation device 10 relating to the present embodiment, the first agent 22 is instructed to provide a weather report, during playback of an audiobook by the second agent 24.

FIG. 7 is a flowchart illustrating a modified example of the response output processing.

FIG. 8 is a sequence diagram illustrating a case in which, at the agent cooperation device 10 relating to the present embodiment at which the response output processing of the modified example is applied, the first agent 22 is instructed to playback music, during playback of an audiobook by the second agent 24.

FIG. 9 is a sequence diagram illustrating a case in which, at the agent cooperation device 10 relating to the present embodiment at which the response output processing of the modified example is applied, the first agent 22 is instructed to provide a weather report, during playback of an audiobook by the second agent 24.

### DETAILED DESCRIPTION

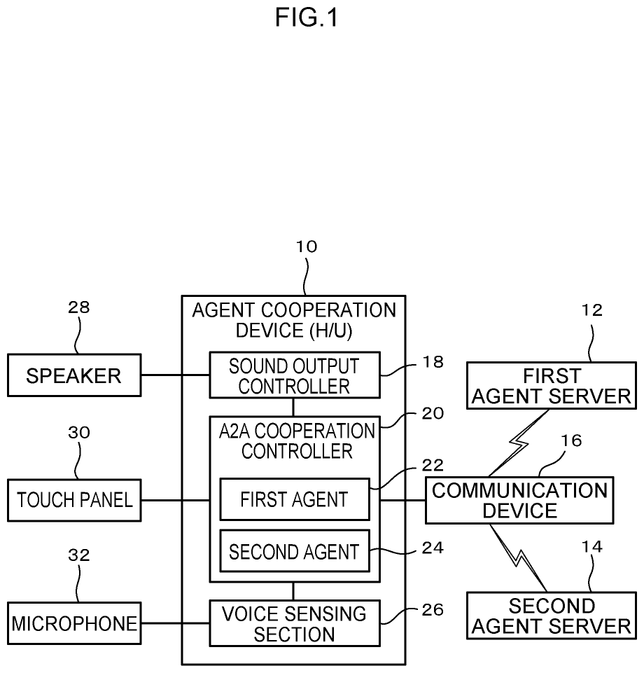

Exemplary embodiments of the present disclosure are described in detail hereinafter with reference to the drawings. FIG. 1 is a block diagram illustrating the schematic structure of an agent cooperation device relating to a present embodiment.

Description will be given by using, as an example, a case in which an agent cooperation device 10 relating to the present embodiment is incorporated in a head unit (H/U) that is installed as an onboard device.

The agent cooperation device 10 is connected to plural agent servers via a communication device 16. In the present embodiment, for example, the agent cooperation device 10 is connected to two agent servers that are a first agent server 12 and a second agent server 14. By carrying out communication with these two agent servers, the agent cooperation device 10 provides a user with services that the respective agent servers provide. Further, the agent cooperation device 10 has the function of controlling output of sounds from the respective agent servers.

Each of the first agent server 12 and the second agent server 14 provides the function of a voice dialogue assistant that is referred to as a Virtual Personal Assistant (VPA). Specifically, a predetermined service such as playback of music, playback of an audiobook, providing of a weather report, or the like is provided to a user by a voice dialogue via the agent cooperation device 10. Because any of various known techniques may be used as the detailed structures of the agent server, description is omitted.

In the present embodiment, the communication device 16 is a communication instrument dedicated for a vehicle, and carries out communication between the agent cooperation device 10 and the first agent server 12, and between the agent cooperation device 10 and the second agent server 14. For example, these respective communications are carried out via a wireless communication network of a cell phone or the like. For example, a communication device called a Data Communication Module (DCM) is used as the communication device 16.

The agent cooperation device 10 is, for example, structured by a general microcomputer that includes a Central Processing Unit (CPU), a Read Only Memory (ROM), a Random Access Memory (RAM), and the like. The agent cooperation device 10 includes functions of a sound output controller 18 that serves as an example of the sound output section, an A2A cooperation controller 20 that serves as an example of the control section, and a voice sensing section 26.

The sound output controller 18 is connected to a speaker 28, and controls sound output from the first agent server 12 and the second agent server 14.

The A2A cooperation controller 20 is connected to a touch panel 30, the sound output controller 18 and the voice sensing section 26, and transmits and receives information to and from these sections. Further, the A2A cooperation controller 20 has the functions of a first agent 22 and a second agent 24. The first agent 22 is provided in correspondence with the first agent server 12, and controls communications with the first agent server 12. Further, the second agent 24 is provided in correspondence with the second agent server 14, and controls communications with the second agent server 14. In response to receiving information relating to a voice dialogue from any of the agent servers, the A2A cooperation controller 20 notifies the sound output controller 18. The sound output controller 18 thereby controls sound output from the speaker 28 based on the information relating to the voice dialogue.

The voice sensing section 26 is connected to a microphone 32, and senses voice information obtained from the microphone 32, and notifies the A2A cooperation controller 20 of the results of sensing. For example, the voice sensing section 26 senses a wakeup word for activating an agent.

An example of the specific operations carried out at the respective sections of the agent cooperation device 10 of the present embodiment structured as described above, are described next.

In the agent cooperation device 10 relating to the present embodiment, the voice sensing section 26 senses a wakeup word, and notifies the A2A cooperation controller 20, and the A2A cooperation controller 20 connects to the corresponding agent server via the communication device 16.

The sound output controller 18 controls the output of a sound from the speaker 28 in accordance with a request for sound output (a voice dialogue, music, an audiobook, or the like) from an agent server.

In a case in which, a voice dialogue is provided with respect to either one of the agents among the first agent 22 and the second agent 24, while the other agent is playing music or an audiobook, the A2A cooperation controller 20 controls the sound output controller 18 so as to lower the volume of or stop the playback that is being carried out.

Further, in a case in which one agent receives a voice dialogue while another agent is performing playback, the A2A cooperation controller 20 carries out control so as to lower the volume of the playback by the other agent, and, at the time when the one agent outputs a response voice to the voice dialogue, stop the sound that is being played by the other agent.

Further, in a case in which one agent receives a voice dialogue while another agent is performing playback, the A2A cooperation controller 20 carries out control so as to lower the volume of the playback by the other agent, and, while the one agent is outputting a response voice, stop the sound that that is being played by the other agent, and, after the voice dialogue with the one agent ends, restart the sound of the playback by the other agent.

Further, in a case in which one agent is to playback music or an audiobook while another agent is performing playback of music or an audiobook, the A2A cooperation controller 20 carries out control so as to, at the time when the one agent receives a voice dialogue, lower the volume of the playback that is being carried out by the other agent, and, at the time when the one agent starts playback of music or an audiobook, stop the playback of the music or the audiobook by the other agent.

Moreover, in a case in which one agent outputs a response voice to a voice dialogue while another agent is performing playback of music or an audiobook, the A2A cooperation controller 20 carries out control so as to, at the time when the one agent receives the voice dialogue, lower the volume of the playback that is being carried out by the other agent, and, after the one agent outputs a response voice, return the volume of the playback that is being carried out by the other agent to the original volume.

Specific processings that are carried out at the respective sections of the agent cooperation device 10 relating to the present embodiment are described next.

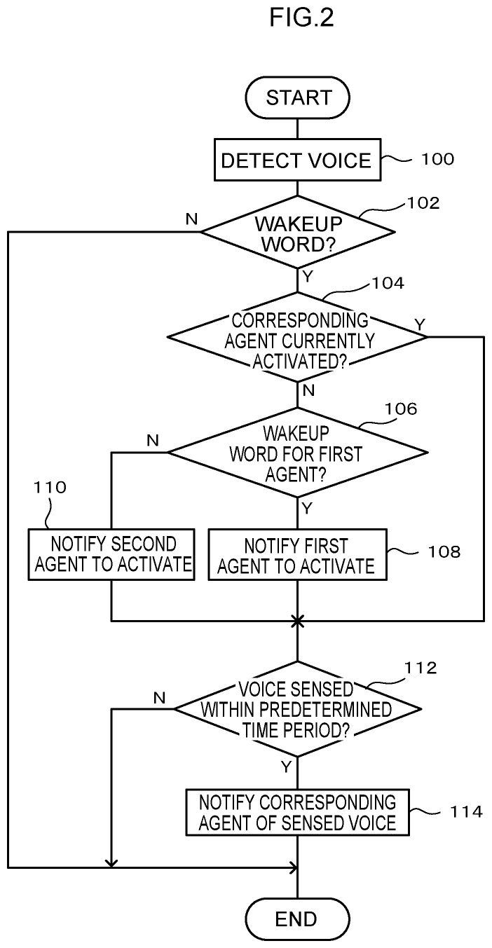

First, the processing carried out at the voice sensing section 26 are described. FIG. 2 is a flowchart illustrating an example of processing flow carried out at the voice sensing section 26 of the agent cooperation device 10 relating to the present embodiment. The processing of FIG. 2 start, for example, in a case in which a voice is input to the voice sensing section 26 from the microphone 32.

In step 100, the voice sensing section 26 carries out voice detection, and the routine moves on to step 102. Namely, the voice sensing section 26 detects the voice input from the microphone 32.

In step 102, the voice sensing section 26 judges whether or not a wakeup word has been detected. This judgment is a judgment as to whether or not a predetermined wakeup word for activating the first agent 22, or a predetermined wakeup word for activating the second agent 24, has been detected. If this judgment is affirmative, the routine moves on to step 104, and if this judgment is negative, the series of processings ends.

In step 104, the voice sensing section 26 judges whether or not the agent corresponding to the wakeup word is currently activated. If this judgment is negative, the routine moves on to step 106, and, if this judgment is affirmative, the routine moves on to step 112.

In step 106, the voice sensing section 26 judges whether or not the detected wakeup word is for the first agent 22. If this judgment is affirmative, the routine moves on to step 108. If the wakeup word for the second agent 24 has been detected and the judgment is negative, the routine moves on to step 110.

In step 108, the voice sensing section 26 notifies the first agent 22 that it is to activate, and the routine moves on to step 112.

In step 110, the voice sensing section 26 notifies the second agent 24 that it is to activate, and the routine moves on to step 112.

In step 112, the voice sensing section 26 judges whether or not a voice is sensed within a predetermined time period. If this judgment is negative, i.e., if a voice is not sensed within the predetermined time period, the series of processing ends. If the judgment is affirmative, the routine moves on to step 114.

In step 114, the voice sensing section 26 notifies the corresponding agent of the sensed voice, and ends the series of processings. Namely, if a voice is sensed within the predetermined time period after the sensing of the wakeup word of the first agent 22, the voice sensing section 26 notifies the first agent 22 of the sensed voice. If a voice is sensed within the predetermined time period after the sensing of the wakeup word of the second agent 24, the voice sensing section 26 notifies the second agent 24 of the sensed voice.

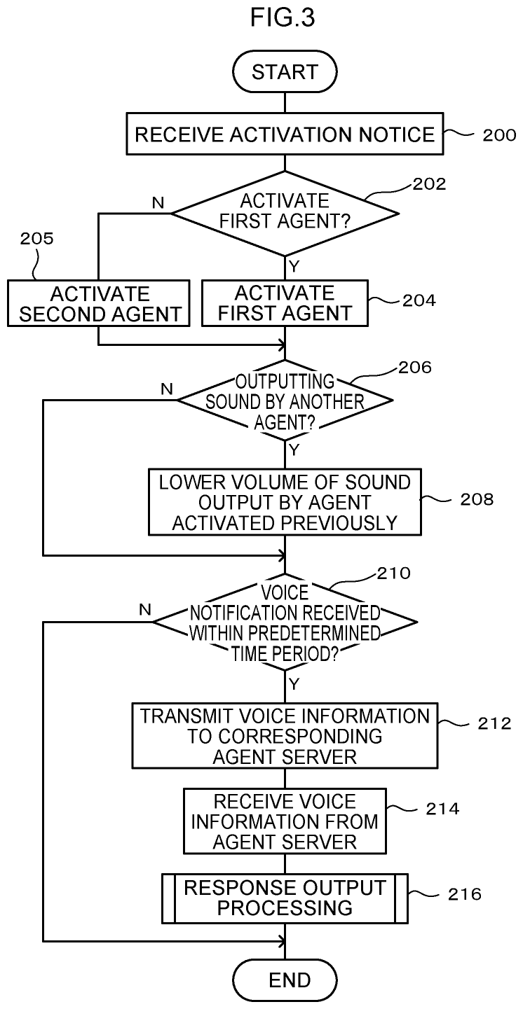

Processing at the A2A cooperation controller 20 is described next. FIG. 3 is a flowchart illustrating an example of the specific processing flow carried out at the A2A cooperation controller 20 of the agent cooperation device 10 relating to the present embodiment. The processing of FIG. 3 start in a case in which a notice of activation of an agent is received from the voice sensing section 26.

In step 200, the A2A cooperation controller 20 receives an agent activation notification, and the routine moves on to step 202. Namely, the A2A cooperation controller 20 receives the agent activation notification given in step 108 or step 110 of FIG. 2.

In step 202, the A2A cooperation controller 20 judges whether or not the agent activation notification received from the voice sensing section 26 is an activation notification for the first agent 22. If this judgment is affirmative, the routine moves on to step 204, and if this judgment is negative, the routine moves on to step 205.

In step 204, the first agent 22 is activated, and the routine moves on to step 208. Specifically, communication between the first agent 22 and the first agent server 12 is established, and the system transitions to a state in which the provision of service from the first agent server 12 is possible.

In step 205, the second agent 24 is activated, and the routine moves on to step 206. Specifically, communication between the second agent 24 and the second agent server 14 is established, and the system transitions to a state in which the provision of service from the second agent server 14 is possible.

In step 206, the A2A cooperation controller 20 judges whether or not the another agent is currently activated. In a case in which one of the first agent 22 and the second agent 24 has received voice information, this judgment is a judgment as to whether or not the other of the first agent 22 and the second agent 24 is currently activated. If this judgment is affirmative, the routine moves on to step 208, and, if this judgment is negative, the routine moves on to step 210.

In step 208, the A2A cooperation controller 20 lowers the volume of the sound output by the agent that has been activated previously, and the routine moves on to step 210. Namely, the A2A cooperation controller 20 instructs the sound output controller 18 to lower the volume of the sound output (e.g., an audiobook or music or the like) by the agent that has been previously activated. Due thereto, the volume of the sound source that is already outputting is lowered, and it becomes easy to hear the dialogue with the agent. Note that, in step 208, the sound output during the dialogue may be stopped temporarily, rather the volume thereof being lowered.

In step 210, the A2A cooperation controller 20 judges whether or not a voice notification has been received from the voice sensing section 26 within a predetermined time period. In this judgment, it is judged whether or not a voice notification has been received by above-described step 114. If this judgment is affirmative, the routine moves on to step 212, and, if this judgment is negative, the series of processings ends.

In step 212, the A2A cooperation controller 20 transmits the voice information from the corresponding agent to the corresponding agent server, and the routine moves on to step 214. Namely, in a case in which the first agent 22 is activated and receives a voice notification, the first agent 22 transmits the voice information to the first agent server 12. In a case in which the second agent 24 is activated and receives a voice notification, the second agent 24 transmits the voice information to the second agent server 14.

In step 214, the A2A cooperation controller 20 receives voice information from the agent server, and the routine moves on to step 216. For example, in step 212, in a case in which voice information whose contents are to playback an audiobook or music is transmitted to the agent server, the agent server carries out semantic analysis on the basis of the voice information, and the A2A cooperation controller 20 receives the voice information to playback the corresponding audiobook or music.

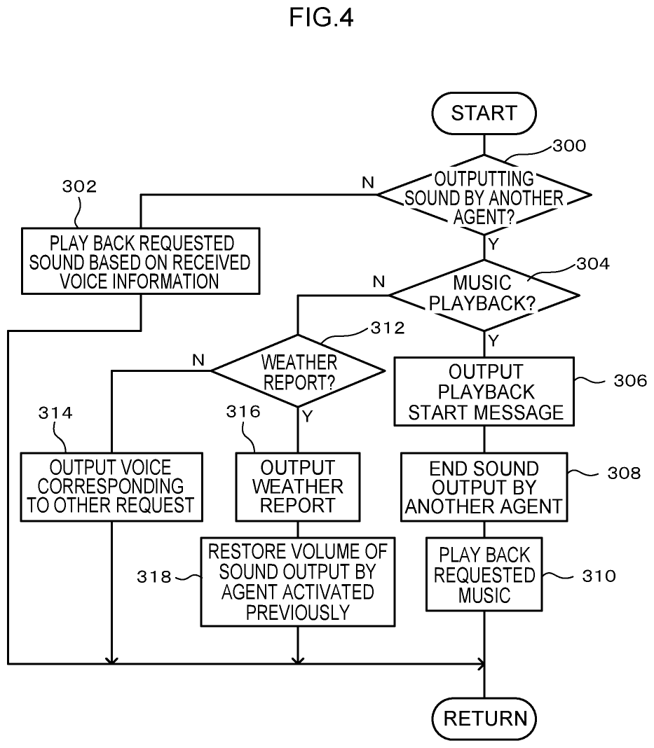

In step 216, the A2A cooperation controller 20 carries out response output processing, and ends the series of processings. The response output processing is processing that gives a response to the dialogue from the user, and, for example, the processing illustrated in FIG. 4 is carried out. FIG. 4 is a flowchart illustrating an example of the response output processing.

Namely, in step 300, the A2A cooperation controller 20 judges whether or not another agent is currently outputting sound. If this judgment is negative, the routine moves on to step 302. If this judgment is affirmative, the routine moves on to step 304.

In step 302, on the basis of the voice information received from the agent server, the A2A cooperation controller 20 carries out the requested sound playback, and returns the processing of FIG. 4 to the processing of FIG. 3 and ends the series of processings.

In step 304, the A2A cooperation controller 20 judges whether or not the voice information received from the agent server is music playback. If this judgment is affirmative, the routine moves on to step 306. If this judgment is negative, the routine moves on to step 312.

In step 306, the A2A cooperation control 20 controls the sound output controller 18 to output a playback start message, and the routine moves on to step 308.

In step 308, the A2A cooperation controller 20 ends the sound output by the other agent, and the routine moves on to step 310.

In step 310, the A2A cooperation controller 20 controls the sound output controller 18 so as to playback the requested music, i.e., the music designated by the voice information received from the agent server, and returns the processing of FIG. 4 to the processing of FIG. 3 and ends the series of processings.

In step 312, the A2A cooperation controller 20 judges whether or not the voice information received from the agent server is a weather report. If this judgment is negative, the routine moves on to step 314, and, if this judgment is affirmative, the routine moves on to step 316.

In step 314, the A2A cooperation controller 20 outputs a voice corresponding to a request other than the weather report, and returns the processing of FIG. 4 to the processing of FIG. 3 and ends the series of processings.

In step 316, the A2A cooperation controller 20 controls the sound output controller 18 such that a weather report that is expressed by the voice information received from the agent server is output, and the routine moves on to step 318. Namely, the weather report is output while the volume of the sound output (e.g., an audiobook, music, or the like) by the other agent is lowered. Therefore, the audibility of the weather report may be improved.

In step 318, the A2A cooperation controller 20 controls the sound output controller 18 so as to restore the volume of the sound output by the other agent that has been activated previously, and returns the processing of FIG. 4 to the processing of FIG. 3 and ends the series of processings.

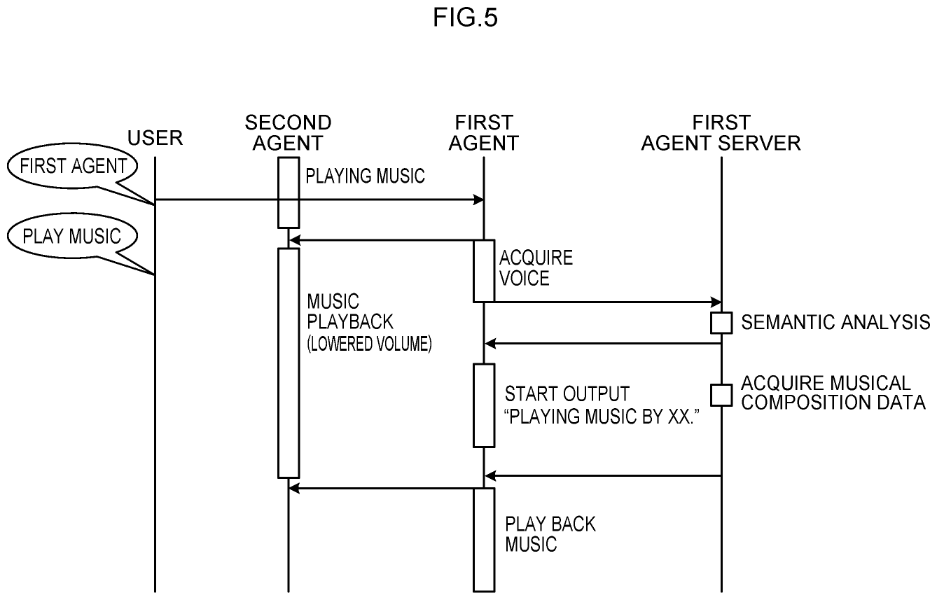

Here, operation of the agent cooperation device 10 relating to the present embodiment is described by using a specific example. FIG. 5 is a sequence diagram in a case in which, at the agent cooperation device 10 relating to the present embodiment, the first agent 22 is instructed to play music during the second agent 24 is playing music. Note that, although a case in which the first agent 22 is instructed to play music while the second agent 24 is playing music by is described as an example, the present disclosure is not limited to this. For example, operation is similar also in a case in which the first agent 22 is instructed to play music or an audiobook, while the second agent 24 is playing music or an audiobook.

As illustrated in FIG. 5, a user speaks “first agent”, which is the wakeup word of the first agent 22, while the second agent 24 is playing music. Due thereto, at the voice sensing section 26, a voice is detected in above-described step 100, the judgment in step 102 is affirmative, and the judgment in step 104 is negative. Then, the judgment in step 106 is affirmative, and, at step 108, the first agent 22 is notified that it is to activate. After notice of activation of the first agent 22 is given, the A2A cooperation controller 20 receives an activation notice at above-described step 200, the judgment in step 202 is affirmative, and the first agent 22 is activated at step 204. At this time, because the second agent 24 is playing music, the judgment of step 206 is affirmative, and the volume of the music playback by the second agent 24 is lowered at step 208.

Further, in response to the user's speech of “play music” within a predetermined time period following the wakeup word, at the voice sensing section 26, the judgment of step 112 is affirmative, and the first agent 22 is notified of the voice at step 114. In response to the notification of the voice given, at the A2A cooperation controller 20, the judgment of above-described step 210 is affirmative, and the spoken voice is transmitted to the first agent server 12 at step 212. Then, semantic analysis is carried out by the first agent server 12, the first agent 22 of the A2A cooperation controller 20 receives a response at step 214, and response output processing is carried out at step 216.

In the response output processing, the judgments of above-described steps 300 and 304 are affirmative, and, at step 306, a playback start message is output from the first agent 22. Namely, as illustrated in FIG. 5, in the state in which the volume of the music playback of the second agent 24 has been lowered, a message such as “Playing music by xx.” is output from the first agent 22. At this time, at step 308, the playing back of music by the second agent 24 is ended. Then, at step 310, music is played by the first agent 22.

By carrying out processing in this way, in the example of FIG. 5, a response voice given by a voice dialogue is made easy to hear, and playback of music by the first agent 22 may be carried out while omitting an instruction to stop the music being played by the second agent 24.

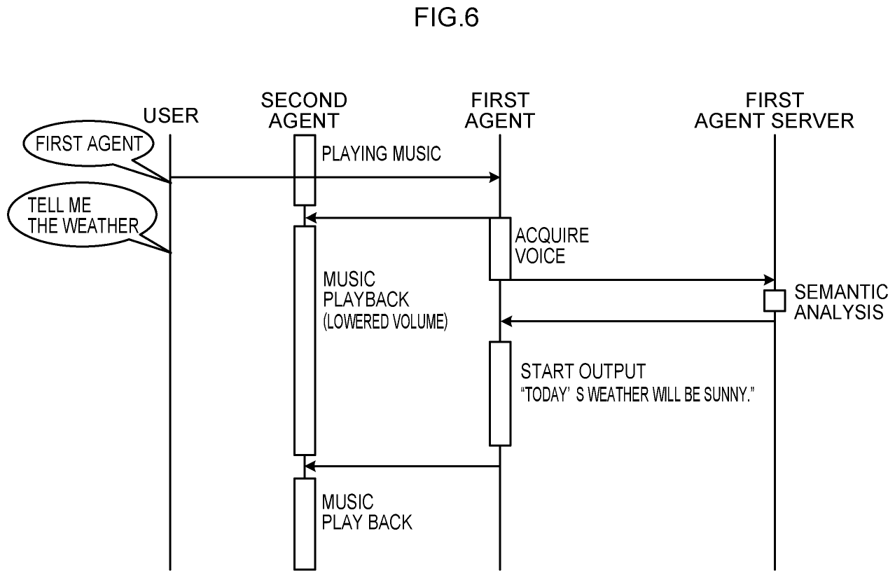

FIG. 6 is a sequence diagram of a case in which, at the agent cooperation device 10 relating to the present embodiment the first agent 22 is instructed to provide a weather report, while the second agent 24 is playing music. Note that, as an example, a case is described in which the first agent 22 is instructed to provide a weather report while the second agent 24 is playing music, but the present disclosure is not limited to this. For example, operation is similar also in a case in which the first agent 22 is instructed to provide a weather report or another service while the second agent 24 is playing music or an audiobook.

As illustrated in FIG. 6, the user speaks “first agent”, which is the wakeup word for the first agent 22, while the second agent 24 is playing music. Due thereto, at the voice sensing section 26, a voice is detected at above-described step 100, the judgment in step 102 is affirmative, and the judgment in step 104 is negative. Then, the judgment in step 106 is affirmative, and, at step 108, the first agent 22 is notified that it is to activate. After notice is given of activation of the first agent 22, the A2A cooperation controller 20 receives an activation notice at above-described step 200, the judgment in step 202 is affirmative, and the first agent 22 is activated by step 204. At this time, because the second agent 24 is playing music, the judgment of step 206 is affirmative, and the volume of the music playback by the second agent 24 is lowered at step 208.

Further, in response to the user's speech of “tell me the weather” within a predetermined time period following the wakeup word, at the voice sensing section 26, the judgment of step 112 is affirmative, and the first agent 22 is notified of the voice at step 114. After notification of the voice is given, at the A2A cooperation controller 20, the judgment of above-described step 210 is affirmative, and the spoken voice is transmitted to the first agent server 12 at step 212. Then, semantic analysis is carried out by the first agent server 12, the first agent 22 of the A2A cooperation controller 20 receives a response at step 214, and response output processing is carried out at step 216.

In the response output processing, the judgment of above-described step 300 is affirmative, the judgment of step 304 is negative, and the judgment of step 312 is affirmative. In step 316, a weather report is output from the first agent 22. Namely, as illustrated in FIG. 6, in the state in which the volume of the music playback of the second agent 24 has been lowered, a weather report such as “Today's weather will be sunny.” is output from the first agent 22. Then, after the output of the weather report ends, in step 318, the volume of the music playback by the second agent 22 is restored.

By carrying out processing in this way, in the example of FIG. 6, the response voice of the first agent 22 may be made easy to hear, even during playback of music by the second agent 24.

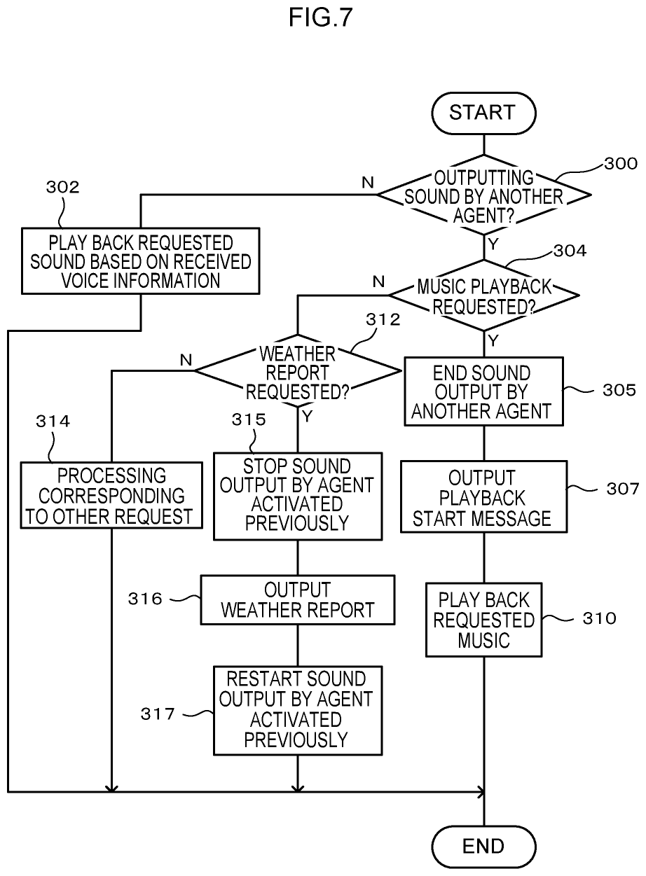

A modified example of the response output processing is described next. FIG. 7 is a flowchart illustrating a modified example of the response output processing. Note that processings that are similar to those of FIG. 4 are described by using the same step numbers.

In step 300, the A2A cooperation controller 20 judges whether or not another agent is currently outputting sound. If this judgment is negative, the routine moves on to step 302. If this judgment is affirmative, the routine moves on to step 304.

In step 302, on the basis of the voice information received from the agent server, the A2A cooperation controller 20 carries out the requested sound playback, and returns the processing of FIG. 7 to the processing of FIG. 3 and ends the series of processings.

In step 304, the A2A cooperation controller 20 judges whether or not the voice information received from the agent server is music playback. If this judgment is affirmative, the routine moves on to step 305. If this judgment is negative, the routine moves on to step 312.

In step 305, the A2A cooperation controller 20 ends the sound output by the other agent, and the routine moves on to step 307.

In step 307, the A2A cooperation controller 20 controls the sound output controller 18 so as to output a playback start message, and the routine moves on to step 310.

In step 310, the A2A cooperation controller 20 controls the sound output controller 18 so as to playback the requested music, i.e., the music designated by the voice information received from the agent server, and returns the processing of FIG. 7 to the processing of FIG. 3 and ends the series of processings.

In step 312, the A2A cooperation controller 20 judges whether or not the voice information received from the agent server is a weather report. If this judgment is negative, the routine moves on to step 314, and, if this judgment is affirmative, the routine moves on to step 315.

In step 314, the A2A cooperation controller 20 outputs a voice corresponding to a request other than the weather report, and returns the processing of FIG. 7 to the processing of FIG. 3 and ends the series of processings.

In step 315, the A2A cooperation controller 20 stops the sound output by the other agent that has been previously activated, and the routine moves on to step 316. Namely, the A2A cooperation controller 20 instructs the sound output controller 18 to stop the sound output (e.g., an audiobook, music or the like) by the other agent that has been previously activated.

In step 316, the A2A cooperation controller 20 controls the sound output controller 18 such that a weather report that is expressed by the voice information received from the agent server is output, and the routine moves on to step 317. Namely, the weather report is output in a state in which the sound output (e.g., an audiobook, music, or the like) by the other agent is stopped. Therefore, the audibility of the weather report may be improved.

In step 317, the A2A cooperation controller 20 controls the sound output controller 18 so as restart the sound output by the other agent that has been activated previously, and returns the processing of FIG. 7 to the processing of FIG. 3 and ends the series of processings.

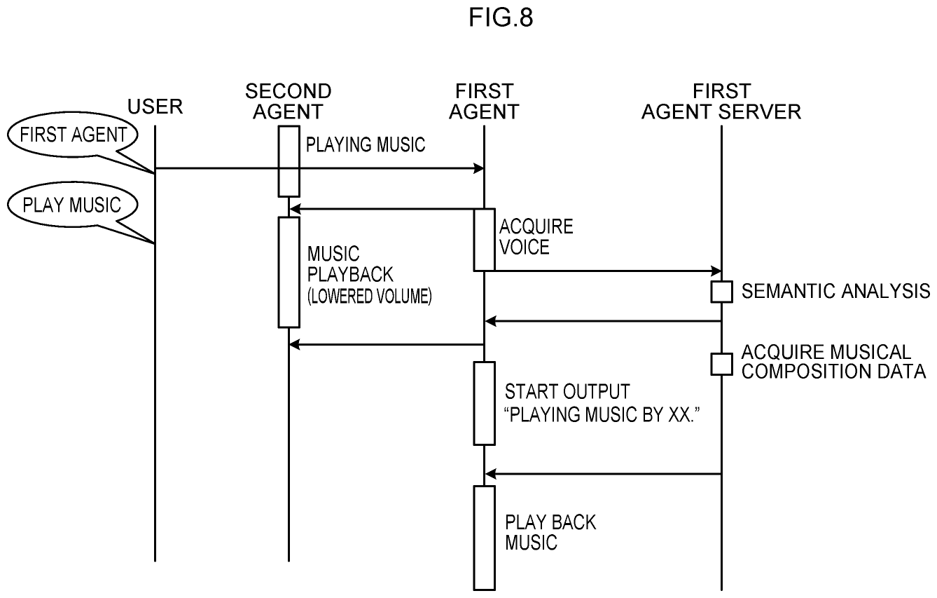

Here, operation of the agent cooperation device 10 relating to the present embodiment at which the response output processing of the modified example is applied, is described by using a specific example. FIG. 8 is a sequence diagram of a case in which, at the agent cooperation device 10 relating to the present embodiment at which the response output processing of the modified example is applied, the first agent 22 is instructed to play music while the second agent 24 is playing another music. Note that, although a case in which the first agent 22 is instructed to playback music while the second agent 24 is playing music is described as an example, the present disclosure is not limited to this. For example, operation is similar also in a case in which the first agent 22 is instructed to play music or an audiobook while the second agent 24 is playing music or an audiobook.

As illustrated in FIG. 8, a user speaks “first agent”, which is the wakeup word of the first agent 22, while the second agent 24 is playing music. Due thereto, at the voice sensing section 26, a voice is detected at above-described step 100, the judgment in step 102 is affirmative, and the judgment in step 104 is negative. Then, the judgment in step 106 is affirmative, and, at step 108, the first agent 22 is notified that it is to activate. After notice of activation of the first agent 22 is given, the A2A cooperation controller 20 receives an activation notice at above-described step 200, the judgment in step 202 is affirmative, and the first agent 22 is activated at step 204. At this time, because the second agent 24 is playing music, the judgment of step 206 is affirmative, and the volume of the music playback by the second agent 24 is lowered by step 208.

Further, in response to the user's speech of “play music” within a predetermined time period following the wakeup word, at the voice sensing section 26, the judgment of step 112 is affirmative, and the first agent 22 is notified of the voice at step 114. After notification of the voice is given, at the A2A cooperation controller 20, the judgment of above-described step 210 is affirmative, and the spoken voice is transmitted to the first agent server 12 at step 212. Then, semantic analysis is carried out by the first agent server 12, the first agent 22 of the A2A cooperation controller 20 receives a response at step 214, and response output processing is carried out at step 216.

In the response output processing, the judgments of above-described steps 300 and 304 are affirmative. After the playback of music by the second agent 24 ends at step 305, in step 307, a playback start message is output from the first agent 22. Namely, as illustrated in FIG. 8, in the state in which playback of music by the second agent 24 is stopped, a message such as “Playing music by xx.” is output from the first agent 22. Then, in step 310, music is played by the first agent 22.

By carrying out processing in this way, in the example of FIG. 8, a response voice given by a voice dialogue is made easy to hear, and playback of music provided by the first agent 22 may be carried out, while omitting an instruction to stop the music being played by the second agent 24.

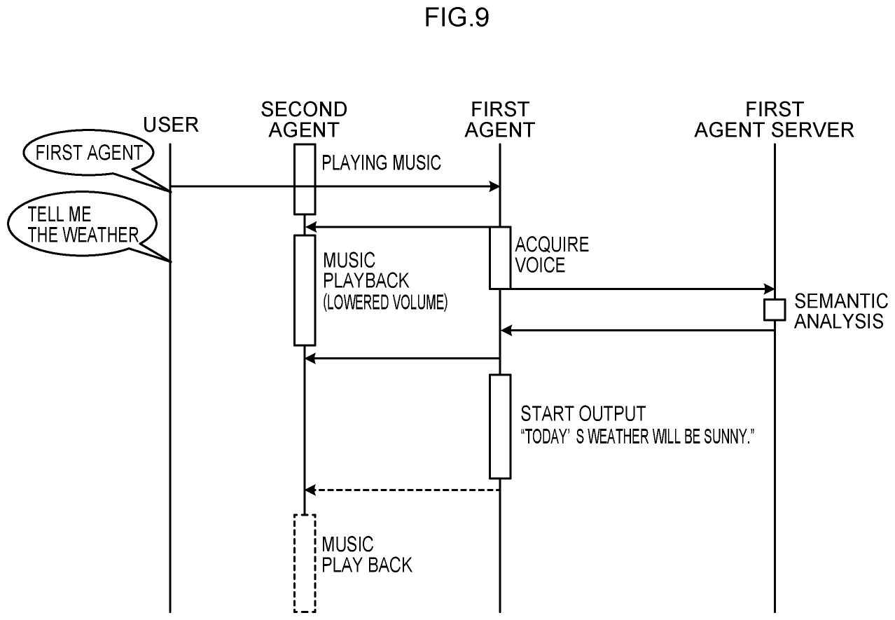

FIG. 9 is a sequence diagram of a case in which, at the agent cooperation device 10 relating to the present embodiment at which the response output processing of the modified example is applied, the first agent 22 is instructed to provide a weather report while the second agent 24 is playing music. Note that, as an example, a case is described in which the first agent 22 is instructed to provide a weather report while the second agent 24 is playing music, but the present disclosure is not limited to this. For example, operation is similar also in a case in which the first agent 22 is instructed to provide a weather report or another service, while the second agent 24 is playing music or an audiobook.

As illustrated in FIG. 9, a user speaks “first agent”, which is the wakeup word for the first agent 22, while the second agent 24 is playing music. Due thereto, at the voice sensing section 26, a voice is detected at above-described step 100, the judgment in step 102 is affirmative, and the judgment in step 104 is negative. Then, the judgment in step 106 is affirmative, and, at step 108, the first agent 22 is notified that it is to activate. After notice is given of activation of the first agent 22, the A2A cooperation controller 20 receives an activation notice at above-described step 200, the judgment in step 202 is affirmative, and the first agent 22 is activated at step 204. At this time, because the second agent 24 is playing music, the judgment of step 206 is affirmative, and the volume of the music playback by the second agent 24 is lowered at step 208.

Further, in response to the user's speech of “tell me the weather” within a predetermined time period following the wakeup word, at the voice sensing section 26, the judgment of step 112 is affirmative, and the first agent 22 is notified of the voice at step 114. After notification of the voice is given, at the A2A cooperation controller 20, the judgment of above-described step 210 is affirmative, and the spoken voice is transmitted to the first agent server 12 at step 212. Then, semantic analysis is carried out by the first agent server 12, the first agent 22 of the A2A cooperation controller 20 receives a response at step 214, and response output processing is carried out at step 216.

In the response output processing, the judgment of above-described step 300 is affirmative, the judgment of step 304 is negative, and the judgment of step 312 is affirmative. After playing of music by the second agent 24 is stopped in step 315, a weather report is output from the first agent 22 in step 316. Namely, as illustrated in FIG. 9, in the state in which the playing of music by the second agent 24 is stopped, a weather report such as “Today's weather will be sunny.” is output from the first agent 22. Then, after output of the weather report ends, as illustrated by the dotted line in FIG. 9, playing of music by the second agent 24 is restarted in step 318. Alternatively, in the dotted line region of FIG. 9, playing of music by the second agent 24 may be ended without restarting the playing of the music.

By carrying out processing in this way, in the example of FIG. 9, the response voice of the first agent 22 may be made easy to hear, even during playback of music by the second agent 24.

Note that, the above-described embodiments describe cases in which the first agent 22 and the second agent 24 provide services of playing of music, playing an audiobook or providing of a weather report, in FIG. 4 and FIG. 7. However, the services are not limited to these.

Further, although the above-described embodiment describe examples in which there are two agents that are the first agent 22 and the second agent 24, the present disclosure is not limited to this, and there may be three or more agents. In this case, in a case in which a voice dialogue is carried out with respect to one agent of the plural agents while another agent is playing music or an audiobook, it suffices for the A2A cooperation controller 20 to control the sound output control section such that the volume of the playback being carried out is lowered or the playback being carried out is stopped.

Although description has been given in which the processings carried out at the agent cooperation device 10 in the above-described respective embodiments are software processings performed by the CPU executing programs, the present disclosure is not limited to this. For example, the processings may be processings that are carried out by hardware using Graphics Processing Units (GPUs), Application Specific Integrated Circuits (ASICs), Field-Programmable Gate Arrays (FPGAs) or the like. Or, the processings may be processings realized by a combination of software and hardware. In the case of software processings, the programs may be stored on any of various types of storage media and distributed.

The present disclosure is not limited to the above embodiments, and can of course be implemented by being modified in various ways other than above embodiments within a scope that does not depart from the gist thereof.

What is claimed is:

1. An agent cooperation device, comprising:
a sound output section that controls sound output in accordance with instructions from a plurality of agents that are configured to receive an instruction regarding a predetermined service by voice dialogue;
a memory; and
a processor that is coupled to the memory and is configured to:
in a case in which a voice dialogue is provided with respect to one of the plurality of agents while another agent is playing music or an audiobook as a service, control the sound output section so as to lower a volume of, or stop, playback that is being carried out by the other agent.

2. The agent cooperation device of claim 1, wherein the processor is configured to control the sound output section so as to lower the volume of the playback that is being carried out by the other agent in a case in which the one agent receives a voice dialogue during the playback, and to stopsound of the playback when the one agent outputs a response voice to the voice dialogue.

3. The agent cooperation device of claim 1, wherein the processor is configured to control the sound output section so as to lower the volume of the playback that is being carried out by the other agent in a case in which the one agent receives a voice dialogue during the playback, to stop sound of the playback while the one agent outputs a response voice, and to restart the sound of the playback after the voice dialogue with the one agent ends.

4. The agent cooperation device of claim 1, wherein the processor is configured to control the sound output section so as to, in a case in which the one agent is to play music or an audiobook, while the other agent is playing music or an audiobook, lower a volume of the playback that is being carried out by the other agent when the one agent receives the voice dialogue, and stop the playback of the music or the audiobook by the other agent when the one agent starts playback of music or an audiobook.

5. The agent cooperation device of claim 1, wherein the processor is configured to control the sound output section so as to, in a case in which the one agent is to output a voice response to a voice dialogue while the other agent is playing music or an audiobook, lower a volume of the playback that is being carried out by the other agent when the one agent receives the voice dialogue, and restore the volume of the playback that is being carried out by the other agent after the one agent outputs the voice response.

6. A method of operating an agent cooperation device that includes functions of a plurality of agents that are configured to receive an instruction regarding a predetermined service by voice dialogue, and a sound output section that controls sound output from the plurality of agents, the method comprising:
detecting a voice dialogue with respect to one agent among the plurality of agents;
determining whether or not another agent among the plurality of agents is playing music or an audiobook as the service; and
controlling the sound output section so as to lower a volume of, or stop, playback that is being carried out by the other agent, in a case in which it is determined that the other agent is carrying out the playback.

7. A non-transitory storage medium storing a program that is executable by a computer to perform agent cooperation processing, the computer being configured to perform functions of a plurality of agents that receive an instruction regarding a predetermined service by voice dialogue, and of a sound output section that controls sound output from the plurality of agents, the agent cooperation processing comprising:
detecting a voice dialogue with respect to one agent among the plurality of agents;
determining whether or not another agent among the plurality of agents is playing music or an audiobook as the service; and
controlling the sound output section so as to lower a volume of, or stop, playback that is being carried out by the other agent, in a case in which it is determined that the other agent is carrying out the playback.
